(19) United States
(12) Patent Application Publication
(10) Pub. No.: US 2002/0041353 A1
(43) Pub. Date: Apr. 11, 2002

(54) Chiral smectic liquid crystal device

(76) Inventors: Koji Noguchi, Sagamihara-shi (JP); Hirohide Munakata, Yokohama-shi (JP); Mutsuo Mitsui, Tokyo (JP); Yasufumi Asao, Atsugi-shi (JP); Ryuichiro Isobe, Atsugi-shi (JP)

Correspondence Address: FITZPATRICK CELLA HARPER & SCINTO, 30 ROCKEFELLER PLAZA, NEW YORK, NY, 10112, US

(21) Appl. No.: 09/861,578

(22) Filed: May 22, 2001

(30) Foreign Application Priority Data
May 22, 2000 (JP) 150375/2000 (PAT.

(51) Int. Cl. G02F 1/141

(52) U.S. Cl. 349/133

(57) ABSTRACT

A chiral smectic liquid crystal device is constituted by a chiral smectic liquid crystal; a pair of substrates each provided with an electrode for applying a voltage to the liquid crystal and an alignment control layer formed by oblique vapor deposition, the pair of substrates being oppositely disposed to sandwich the liquid crystal so as to form a plurality of pixels each provided with an active element connected to an associated electrode on at least one of the substrates; and a polarizer provided to at least one of the substrates. The liquid crystal has a phase transition series on temperature decrease of isotropic liquid phase (Iso), cholesteric phase (Ch) and chiral smectic C phase (Smc*) or of Iso and SmC*. Further, the alignment control layer formed by oblique vapor deposition comprises a plurality of columns of deposited material forming an angle of at most 70 degrees with respect to an associated substrate so that liquid crystal molecules in the smectic phase are aligned substantially perpendicular to an extension direction of the columns of deposited material, thus improving a contrast of the resultant chiral smectic liquid crystal device.

### FIELD OF THE INVENTION AND RELATED ART

The present invention relates to a chiral smectic liquid crystal device used for light valves used in flat panel display, projection displays, and printers, etc.

The twisted nematic (TN) mode, disclosed by M. Schadt and W. Helfrich (e.g., in Appl. Physics Letters, Vol. 18, No. 4 (Feb. 15, 1971), p.p. 127 -128, has been used as a representative mode for a nematic liquid crystal device extensively used for display devices using active elements such as thin film transistors (TFTs).

On the other hand, in recent years, liquid crystal displays according to an in-plane switching mode utilizing a lateral electric field and a vertical alignment mode have been proposed to improve the viewing angle characteristic, which has been problematic in the conventional liquid crystal displays.

As described above, several liquid crystal drive modes are known for TFT display devices using nematic liquid crystals, but any drive mode has required a slow response time of several tens of milli-seconds or lager and an improvement in response speed has been demanded.

Some liquid crystal drive modes using chiral smectic liquid crystals have been proposed in recent years for improving the response speed of the conventional nematic liquid crystal devices, inclusive of a short pitch-type ferroelectric liquid crystal mode, a polymer stabilization-type ferroelectric liquid crystal mode and a thresholdless anti-ferroelectric liquid crystal mode, which have been reported as realizing a high-speed responsiveness of sub-millisecond on shorter, though they have not been commercialized.

On the other hand, our research group also has proposed a liquid crystal device wherein a liquid crystal material showing a phase transition series on temperature decrease of isotropic liquid phase (Iso.)-cholesteric phase (Ch)-chiral smectic C phase (SmC*) or of Iso-SmC* causing a direct phase transition from Iso to SmC* so as to provide a monostable state at a position inside a chiral smectic (virtual) cone (e.g., Japanese Laid-Open Patent Application (JP-A) 2000-338464) or at an edge position thereof (e.g., JP-A 2000-010076). At the time of phase transition of Ch-SmC* or Iso-SmC*, a DC voltage is applied across a pair of electrodes sandwiching the liquid crystal to uniformize the smectic layer directions to one direction. As a result, it is possible to realize a liquid crystal device which allows a high-speed response and a gradation control, also exhibits excellent motion picture quality and high luminance and also allows mass production. The liquid crystal device of this type may advantageously be used in combination with active elements such as a TFT because the liquid crystal material used has a relatively small spontaneous polarization compared with those used in the conventional chiral smectic liquid crystal devices. Further, the liquid crystal device described in JP-A 2000-010076 can realize a stable gradational (halftone) display with less hysteresis.

As described above, in a sense of solving the problem of the conventional nematic liquid crystal devices, i.e., improvement in response speed, the realization of a practical liquid crystal device using a chiral smectic liquid crystal, particularly a monostabilized liquid crystal device as proposed by our research group, is expected to be used as a next generation display device with high-speed responsiveness and good gradation display performance in combination.

However, in the above-mentioned chiral smectic liquid crystal device, when an alignment control of liquid crystal molecules is effected by rubbing an organic polymer film represented by a polyimide film, the resultant alignment control layer is accompanied with a problem of occurrence of streaks presumably attributable to the rubbing, thus resulting in a lowering in contrast.

### SUMMARY OF THE INVENTION

A principal object of the present invention is to provide a chiral smectic liquid crystal device having a solved the above-mentioned problems.

A specific object of the present invention is to provide a chiral smectic liquid crystal device using an alignment control layer which can readily be formed through the oblique (vapor) deposition (or evaporation) method, thus allowing a high contrast.

According to the present invention, there is provided a chiral smectic liquid crystal device, comprising

a chiral smectic liquid crystal,

a pair of substrates each provided with an electrode for applying a voltage to the liquid crystal and an alignment control layer formed by oblique vapor deposition, the pair of substrates being oppositely disposed to sandwich the liquid crystal so as to form a plurality of pixels each provided with an active element connected to an associated electrode on at least one of the substrates, and

a polarizer provided to at least one of the substrates; wherein

the liquid crystal has a phase transition series on temperature decrease of isotropic liquid phase (Iso), cholesteric phase (Ch) and chiral smectic C phase (SmC*) or of Iso and SmC*, and

the alignment control layer formed by oblique vapor deposition comprises a plurality of columns of deposited material forming an angle of at most 70 degrees with respect to an associated substrate so that liquid crystal molecules in the smectic phase are aligned substantially perpendicular to an extension direction of the columns of deposited material.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic partial sectional view of a liquid crystal device according to an embodiment of the present invention.

FIG. 2 is a schematic plan view illustrating an arrangement of an active matrix substrate and peripheral drivers in a liquid crystal device according to an embodiment of the present invention.

FIG. 3 is a schematic partial sectional view showing an organization of one pixel portion of the liquid crystal device shown in FIG. 2.

FIG. 4 is a diagram showing an equivalent circuit of the pixel shown in FIG. 3.

FIG. 5 shows an example set of drive signal waveforms for active matrix drive of a liquid crystal device according to the present invention.

FIGS. 6A and 6B are schematic views for illustrating an embodiment of oblique deposition employed in the present invention.

FIGS. 7A-7C are schematic sectional views for illustrating a liquid crystal alignment state and a shape of columns of deposited material, wherein

FIG. 7A shows a state of uniaxially aligned liquid crystal molecules having smectic A phase along oblique column planes of an oblique (vapor) deposition alignment control film,

FIG. 7B shows a state of uniaxially aligned liquid crystal molecules having no smectic A phase having phase transition series of (Iso-Ch-SmC* or Iso-SmC*) along grooves between consecutive columns of an oblique deposition alignment control film, and FIG. 7C is a partially enlarged view of a state of columns of deposited material shown in FIG. 7B.

### DESCRIPTION OF THE PREFERRED EMBODIMENTS

The chiral smectic liquid crystal device according to the present invention is characterized by a combination of an oblique (vapor-)deposited alignment control layer and a chiral smectic liquid crystal having a phase transition of Iso-Ch-SmC* or Iso-SmC*, preferably of Iso-Ch-SmC.

We have found that it is possible to stably provide such a chiral smectic liquid crystal with a uniform uniaxial alignment state by using an alignment control layer formed through oblique (vapor) deposition which is a uniform alignment control method from a microscopic viewpoint.

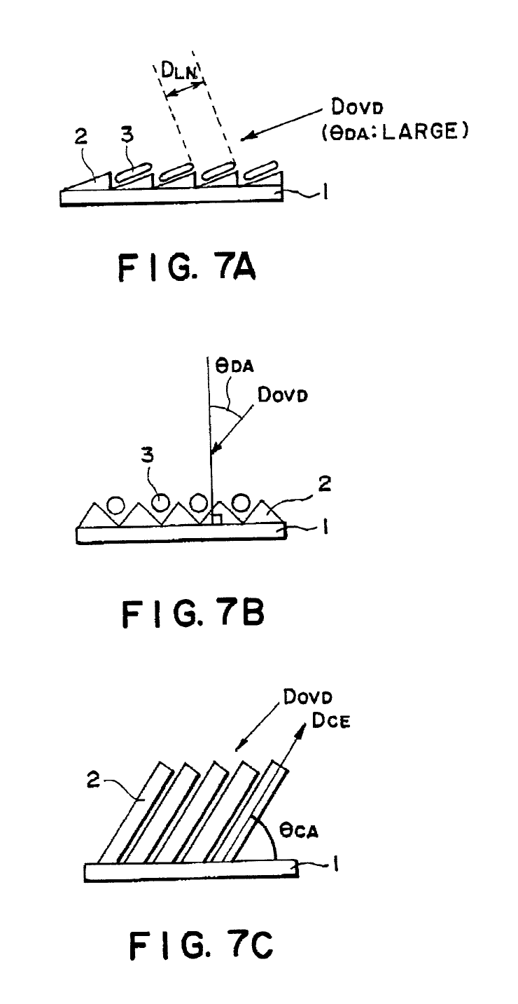

The oblique deposition method is described in detail, e.g., in “Liquid Crystal Device Handbook” (edited by 142 committee of The Japan Society for the Promotion of Science), p.p. 242-. Further, there are many reports on impartment of a uniaxial alignment characteristic to a liquid crystal composition having a phase transition series of Ch (chiral nematic)-SmA (smectic A phase)-SmC* (or SmA-SmC*) by using the oblique deposition method (e.g., “Preprints for Liquid Crystal Forum”, 3Z05 (1987), 3B124 and 3B125 (1988)). According to these reports, in smectic phase, liquid crystal molecules are aligned so that a long-axis direction thereof is in parallel with an oblique vapor deposition direction (D_{OVD}) and a direction of normal (D_{LN}) to smectic molecular layers is also parallel to the oblique deposition direction (D_{OVD}) as shown in FIG. 7A.

Referring to FIG. 7A, when an oblique (vapor) deposition is effected at a relatively large deposition angle θ_{DA} (defined as an angle formed between a direction of oblique vapor deposition D_{OVD} and a normal to a substrate 1 as shown in FIG. 7B), liquid crystal molecules 3 are aligned along oblique surfaces of columns 2 of deposited material (as an alignment control film) formed on a substrate 1. As a result, a layer normal direction D_{LN} of (smectic) liquid crystal molecules is parallel to the oblique vapor deposition direction D_{OVD}.

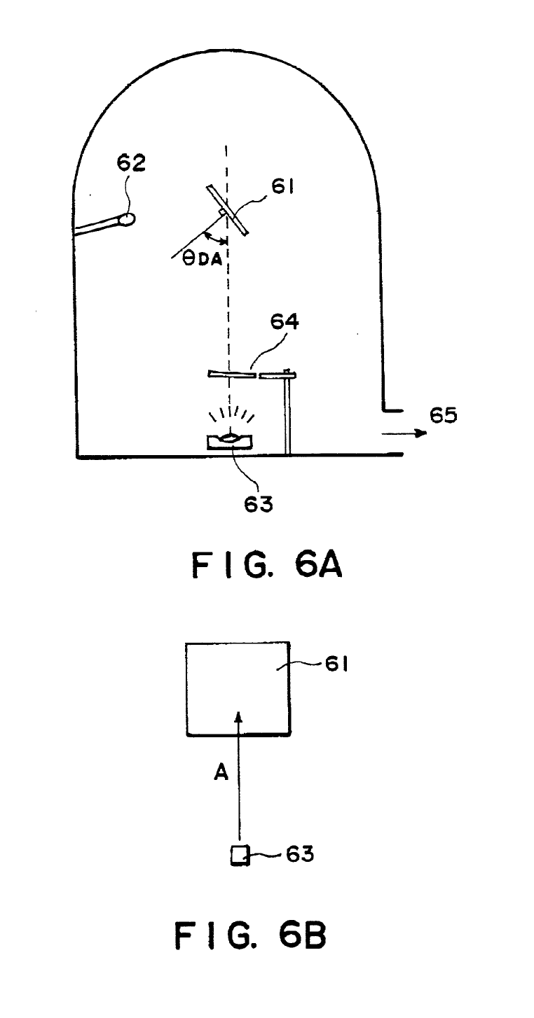

FIGS. 6A and 6B show an embodiment of the oblique deposition method adopted in the present invention, wherein FIG. 7A shows an oblique deposition (evaporation) apparatus and FIG. 6B is a view for illustrating a deposition angle θ_{DA} in combination with FIG. 6A.

Referring to these Figures, the oblique deposition apparatus includes a substrate 61, a thickness monitor 62, a deposition (evaporation) source 63, a shutter 64 designed to open at the time of deposition operation, and an evacuation pump 65. A deposition angle θ_{DA} is an angle formed between a deposition direction A and a normal to the substrate 61.

In the deposition apparatus, a deposition material (e.g., SiO) is evaporated under vacuum pressure by heating at the deposition source 63 and deposited obliquely on the substrate 61 to form a deposited film comprising a plurality of columns of a deposited material.

In the present invention, the columns of the deposited material are formed so that a column extension (long-axis) direction (D_{CE}) forms an angle with the substrate 61 of at most 70 degrees, preferably 30-70 degrees, (herein, the angle is referred to as “column angle (θ_{CA})”) as shown in FIGS. 7B and 7C.

Referring to FIGS. 7B and 7C, the chiral smectic liquid crystal are uniaxially aligned by the obliquely deposited (alignment control) film so that a long-axis direction of smectic liquid crystal molecules 3 is substantially perpendicular to the column extension direction D_{CE} (or the oblique deposition direction D_{OVD}) (i.e., perpendicular to the drawing). In other words, liquid crystal molecule 3 are substantially aligned along with (an extension direction of) grooves formed by adjacent (consecutive) columns 2 of deposited material on a substrate 1.

The column angle θ_{CA} is generally controlled by adjusting the deposition angle θ_{DA} in the deposition apparatus shown in FIG. 6A.

In the case where the layer normal direction D_{LN} of smectic liquid crystal molecules is parallel to the oblique deposition direction D_{OVD} (as shown in FIG. 7A), the liquid crystal molecules are provided with a prescribed pretilt angle (an angle formed between a long molecular axis direction and a substrate surface) depending on a column angle θ_{CA} by the oblique deposition method.

The control of the column angle θ_{CA} by the oblique deposition method is generally very difficult since a deposition material (e.g., SiO) is radially carried from a deposition source in a spot area in general, so that an irregularity (difference) in column angle θ_{CA} when the deposition material is deposited on a large-sized substrate. As a result, in ia liquid crystal panel having a large picture area, an irregularity in pretilt angle is liable to occur within a panel plane, thus leading to an irregularity in device characteristic within the panel plane. This difficulty can also similarly occur in the case where a plurality of liquid crystal panels are prepared from a single substrate having a large size onto which a deposition material is obliquely deposited, thus resulting in an irregularity in device characteristic between the plural liquid crystal panels.

In the present invention, by using the oblique deposition method in combination with the chiral smectic liquid crystal having the Ch (chiral nematic)-SmC* (or Iso-SmC*) phase transition series tree from smectic A phase, it has been found that liquid crystal molecules are uniaxially aligned so that their long-axis direction is substantially perpendicular to the oblique deposition direction D_{OVD} or the column extension direction D_{CE} as shown in FIG. 7B. In such an alignment state, it is generally known that a resultant pretilt angle is almost 0 deg. This is also confirmed by our experiment. According to our experiment, it has been confirmed that by appropriately controlling a column angle θ_{CA} in combination with a liquid crystal material having Ch-SmC* phase transition series, it is possible to provide a liquid crystal device with uniform characteristic over the entire panel plane.

When such a chiral smectic liquid crystal having the Ch-SmC* (or Iso-SmC*) phase transition series is subjected to uniaxial alignment treatment by rubbing a polyimide (alignment) film, it has been known that the long-axis direction of its liquid crystal molecules is deviated by ca. at most 10 deg. from the rubbing direction.

In the case of the oblique deposition method (used in combination with such a chiral smectic liquid crystal), it has been found that the long-axis direction of liquid crystal molecules is slightly obviated from a direction perpendicular to the deposition direction similarly as in the rubbed polyimide film. In this alignment state, the liquid crystal molecules (substantially aligned with grooves of columns of deposited material) are uniformly aligned at a substantially identical level on the basis of an associated substrate, thus providing a pretilt angle of almost 0 deg. As a result, according to the oblique deposition method used in combination with the chiral smectic liquid crystal having the phase transition series (or temperature decrease) of Iso-Ch-SmC* (or Iso-SmC*), it is not necessary to control an alignment state of liquid crystal molecules by strictly adjusting the column angle θ_{CA} as in a conventional manner, thus realizing uniform uniaxial alignment characteristic with less microscopic irregularity while allowing a large process margin (a large latitude in alignment treatment).

In a preferred embodiment, the above-described liquid crystal device is driven for displaying (color) images in a succession of frame periods (per one second) each in which an alignment state of the chiral smectic liquid crystal used is appropriately changed with time.

The chiral smectic liquid crystal used in the present invention is placed in a monostabilized state under no external electric field application as described hereinafter.

The resultant chiral smectic liquid crystal device may employ a liquid crystal material described in the above-mentioned JP-A 2000-338464 and JP-A 2000-010076 wherein a chiral smectic liquid crystal has a phase transition series on temperature decrease of isotropic liquid phase (Iso)-cholesteric phase (Ch)-chiral smectic C phase (SmC*) or Iso-SmC* and liquid crystal molecules are monostabilized at a position inside an edge of or at an edge position of a chiral smectic (virtual) cone, thus realizing an alignment state in SmC* with no memory state.

The chiral smectic liquid crystal used in the present invention, as described above, has a phase transition series on temperature decrease of Iso-Ch-SmC* or Iso-SmC, thus being free from smectic A phase (SmA) (which phase (SmA) is generally confirmed in ordinary chiral smectic liquid crystal materials).

The choral smectic liquid crystal may preferably be a liquid crystal composition prepared by appropriately blending a plurality of liquid crystal materials, e.g., selected from hydrocarbon-type liquid crystal materials containing a biphenyl, phenyl-cyclohexane ester or phenyl-pyrimidine skeleton; naphthalene-type liquid crystal materials; and fluorine-containing liquid crystal materials.

The liquid crystal composition as the chiral smectic liquid crystal used in the chiral smectic liquid crystal device according to the present invention may preferably comprise at least two compounds each represented by the following formulas (1), (2), (3) and (4).

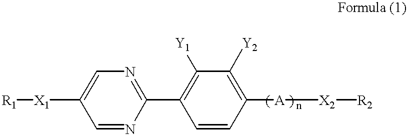

wherein A is

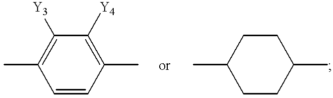

R1 and R2 are independently a linear or branched alkyl group having 1-20 carbon atoms optionally having a substituent, X1 and X2 are independently a single bond O, COO or OOC; Y1, Y2, Y3 and Y4 are independently H or F; and n is 0 or 1.

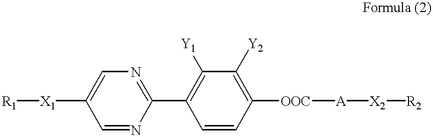

wherein A is

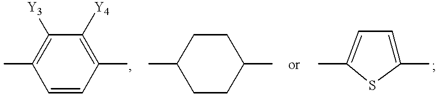

R1 and R2 are independently a linear or branched alkyl group having 1-20 carbon atoms optionally having a substituent; X1 and X2 are independently a single bond O, COO or OOC; and Y1, Y2, Y3 and Y4 are independently H or F.

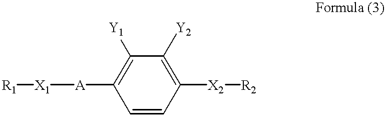

wherein A:

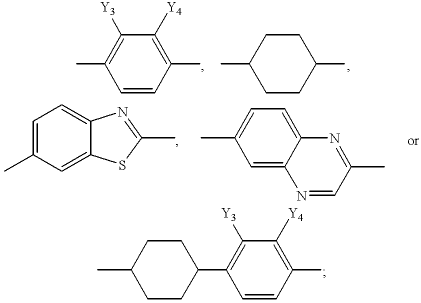

R1 and R2 are independently a linear or branched alkyl group having 1-20 carbon atoms optionally having a substituent; X1 and X2 are independently a single bond O, COO or OOC; and Y1, Y2, Y3 and Y4 are independently H or F.

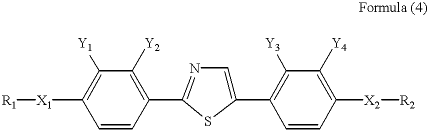

wherein R1 and R2 are independently a linear or branched alkyl group having 1-20 carbon atoms optionally having a substituent; X1 and X2 are independently a single bond, O, COO or OOC; and Y1, Y2, Y3 and Y4 are independently H or F.

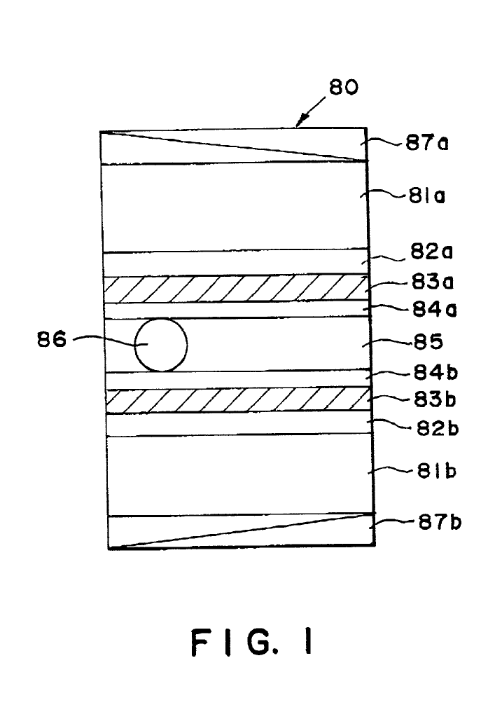

Hereinbelow, an embodiment of the liquid crystal device according to the present invention will be described with reference to FIG. 1.

FIG. 1 shows a schematic sectional view of a liquid crystal device 80 according to the present invention.

Referring to FIG. 1, the liquid crystal device 80 includes a pair of substrates 81a and 81b; electrodes 82a and 82b disposed on the substrates 81a and 81b, respectively; insulating films 83a and 83b disposed on the electrodes 82a and 82b, respectively; alignment control films 84a and 84b disposed on the insulating films 83a and 83b, respectively; a chiral smectic liquid crystal 85 disposed between the alignment control films 84a and 84b; a spacer 86 disposed together with the liquid crystal 85 between the alignment control films 84a and 84b; and a pair of cross-nicol polarizers 87a and 87b (with crossed polarizing axes at right angles) sandwiching the pair of substrates 81a and 81b.

Each of the substrates 81a and 81b comprises a transparent material, such as glass or plastics, and is coated with, e.g., a plurality of stripe electrodes 82a (82b) of In₂O₃ or ITO (indium tin oxide) for applying a voltage to the liquid crystal 85. These electrodes 82b and 82b are arranged in a (dot-)matrix form. In a preferred embodiment, as described later, one of the substrates 81a and 81b is provided with a matrix electrode structure wherein dot-shaped transparent electrodes are disposed as pixel electrodes in a matrix form and each of the pixel electrodes is connected to a switching or active element, such as a TFT (thin film transistor) or MIM (metal-insulator-metal), and the other substrate may be provided with a counter (common) electrode on its entire surface or in an prescribed pattern, thus constituting an active matrix-type liquid crystal device.

On the electrodes 82a and 82b, the insulating films 83a and 83b, e.g., of SiO₂, TiO₂ or Ta₂O₅ having a function of preventing an occurrence of short circuit may be disposed, respectively, as desired.

On the insulating films 83a and 83, the alignment control films 84a and 14b are disposed so as to control the alignment state of the liquid crystal 15 contacting the alignment control films 84a and 84b. Such an alignment control film 84a (84b) may be prepared by forming a deposited film of an inorganic material, such as SiO, SiOx or CaF₂, by using the above-mentioned oblique deposition apparatus shown in FIGS. 6A and 6B.

The substrates 81a and 81b are disposed opposite to each other via the spacer 86 comprising e.g., silica beads for determining a distance (i.e., cell gap) therebetween, preferably in the range of 0.3-10 μm, in order to provide a uniform uniaxial aligning performance and such an alignment state that an average molecular axis of the liquid crystal molecules under no electric field application is substantially aligned with an average uniaxial aligning treatment axis or a bisector of two uniaxial aligning treatment axes) although the cell gap varies its optimum range and its upper limit depending on the liquid crystal material used.

In addition to the spacer 86, it is also possible to disperse adhesive particles of a resin (e.g., epoxy resin) (not shown) between the substrates 81a and 81b in order to improve adhesiveness therebetween and an impact (shock) resistance of the chiral smectic liquid crystal.

The liquid crystal device 80 having the above-mentioned liquid crystal cell structure can be prepared by using a chiral smectic liquid crystal material 85 while adjusting the composition thereof, and further by appropriate adjustment of the liquid crystal material treatment, the device structure including a material, and a treatment condition for alignment control films 84a and 84b. As a result, in a preferred embodiment of the present invention, the liquid crystal material may preferably be placed in an alignment state such that the liquid crystal molecules are aligned to provide an average molecular axis to be mono-stabilized in the absence of an electric field applied thereto and, under application of voltages of one polarity (a first polarity), are tilted in one direction from the average molecular axis under no electric field to provide a tilting angle which varies continuously from the average molecular axis of the monostabilized position depending on the magnitude of the applied voltage. On the other hand, under application of voltages of the other polarity (i.e., a second polarity opposite to the first polarity), the liquid crystal molecules are tilted in the other direction from the average molecular axis under no electric field depending on the magnitude of the applied voltages, thus realizing a halftone (gradation) display. Further, in this embodiment a maximum tilting angle β1 obtained under application of the first polarity voltages based on the monostabilized position is substantially larger than a maximum tilting angle β2 formed under application of the second polarity voltages, i.e., β1>β2, preferably β1>5×β2. Further, β2 may be substantially zero deg., i.e., the average molecular axis is not moved substantially under application of the second polarity voltages.

The liquid crystal device of the present invention may be used as a color liquid crystal device by providing one of the pair of substrates 81a and 81b with a color filter comprising color filter segments (color portions) of at least red (R), green (G) and blue (B). It is also possible to effect a full-color display by successively switching (lighting) a light source comprising R light source, G light source and B light source emitting color light fluxes to effect color mixing in a time division (sequential) manner.

The liquid crystal device of the present invention is of a light-transmission type such that a pair of transparent substrates 81a and 81b are sandwiched between a pair of polarizers to optically modulate incident light (e.g., issued from an external light source) through one of the substrates to be passed through the other substrate. The liquid crystal device of the present invention may be modified into a reflection-type liquid crystal device by providing a reflection plate to either one of the substrates 81a and 81b or using a combination of one of the substrates per se formed of a reflective material or with a reflecting member thereon and the other substrate provided with a polarizer outside thereof, thus optically modulating incident light and reflected light and causing the reflected light to pass through the substrate on the light incident side.

In the present invention, by using the above-mentioned liquid crystal device in combination with a drive circuit for supplying gradation signals to the liquid crystal device, it is possible to provide a liquid crystal display apparatus capable of effecting a gradational display based on the above-mentioned alignment characteristic such that under voltage application, a resultant tilting angle varies continuously from the monostabilized position of the average molecular axis (of liquid crystal molecules) and a corresponding emitting light quantity continuously changes, depending on the applied voltage. For example, it is possible to use, as one of the pair of substrates, an active matrix substrate provided with a plurality of switching elements (e.g., TFT (thin film transistor) or MIM (metal-insulator-metal)) in combination with a drive circuit (drive means), thus effecting an active matrix drive based on amplitude modulation to allow a gradational display in an analog gradation manner.

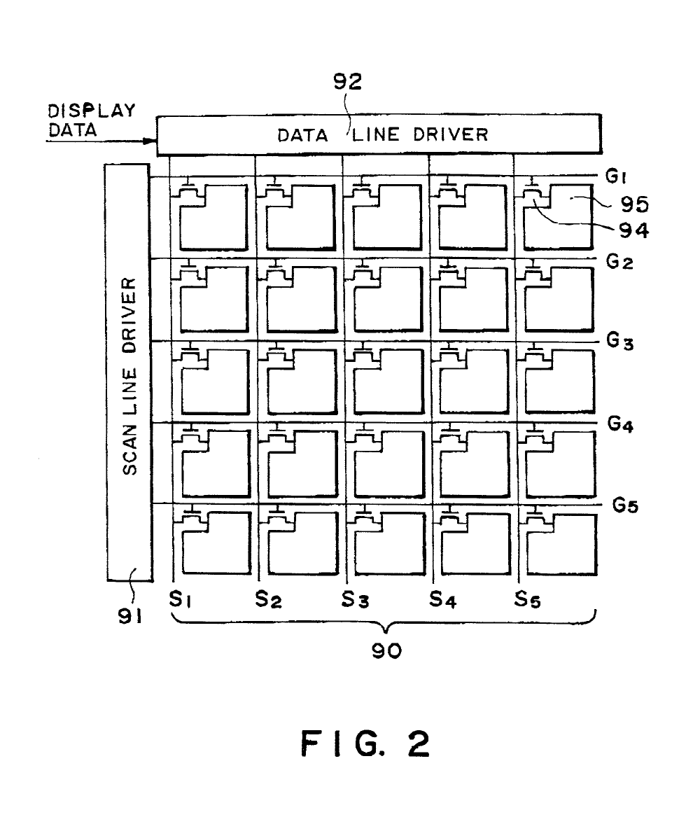

Hereinbelow, an embodiment of the liquid crystal device of the present invention provided with such an active matrix substrate will be described with reference to FIGS. 2-4.

FIG. 2 is a schematic plan view illustrating an arrangement of an active matrix substrate and peripheral drive circuits in a liquid crystal device according to an embodiment of the present invention.

Referring to FIG. 2, in a panel unit 90 corresponding to a liquid crystal device, gate lines G1, G2, . . . corresponding to scanning signal lines which extend laterally and are connected to a scanning signal driver 91, and source lines S1, S2, . . . corresponding to data signal lines which extend vertically and are connected to a data signal driver 92, are disposed to intersect each other while being insulated from each other. At each intersection of the gate lines G1, G2, . . . and the source lines S1, S2, . . . , a TFT (switching element) 94 is disposed and a pixel electrode 95 is connected thereto to form a pixel. FIG. 2 shows only 5×5 pixel regions for convenience of illustration, but a larger number of pixel regions are actually included. As a switching element (active element), it is also possible to use a MIM element instead of TFT.

The gate lines G1, G2, . . . are connected to gate electrodes of TFTs 94, the source lines S1, S2, . . . are connected to source electrodes of the TFTs 94, and the pixel electrodes 95 are connected to drain electrodes of the TFTs 94. Based on the structure, the gate lines G1, G2 . . . are sequentially selected by the scanning signal driver 91 to be supplied with a gate voltage. In synchronism with the sequential scanning selection of the gate lines, data signal voltages corresponding to data written at respective pixels are supplied from the data signal driver 92 via the source liens S1, S2, . . . and TFTs 94 on the selected gate line to the corresponding pixel electrodes 95.

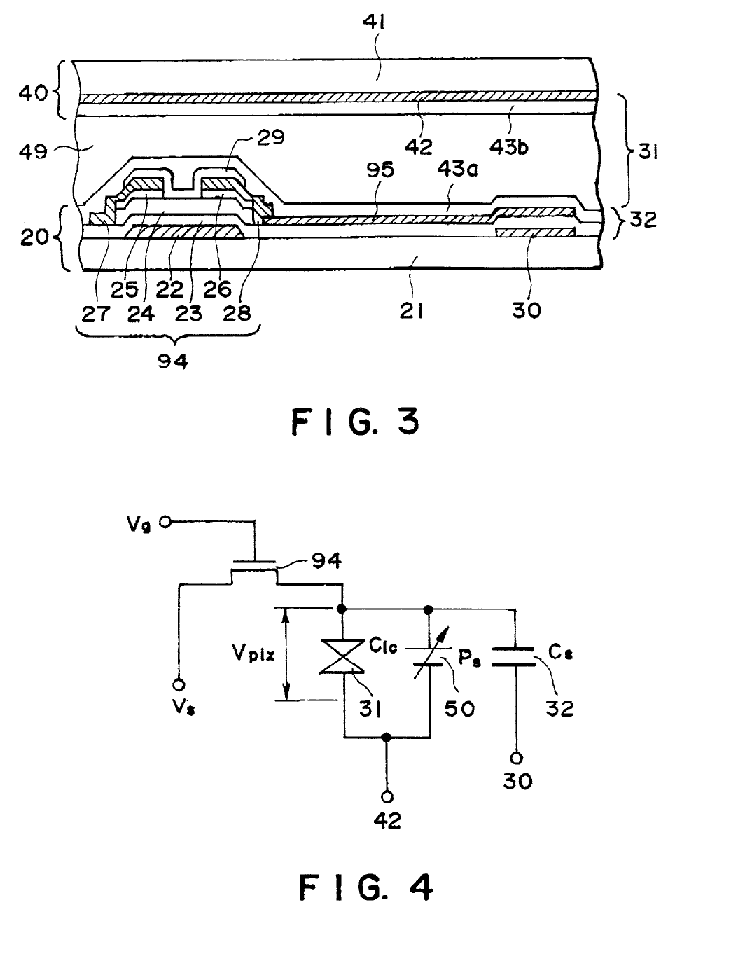

FIG. 3 is a schematic partial sectional view showing an organization of one pixel region of the panel 90 shown in FIG. 2. Referring to FIG. 3, each pixel is formed by an active matrix substrate 20 including a substrate 11, a pixel electrode 95, a TFT 94 including a gate electrode 22 formed thereon, a gate insulating film 23, an a(amorphous)-Si layer 24, n⁺a-Si layers 25 and 26, a source electrode 27, a drain electrode 28 and a channel protection film 29, a holding (storage) capacitor electrode 30 giving a holding (storage) capacitance (Cs) 32 and an alignment control layer 53a; a counter substrate 40 including a transparent substrate 41, a common electrode 42 and an alignment control layer 43b; and a liquid crystal layer 49 giving a liquid crystal capacitance 31 disposed between the active matrix substrate 20 and the counter substrate 40.

Thus, in the structure shown in FIG. 3, the liquid crystal layer 49, e.g., having a spontaneous polarization or assuming a chiral smectic phase is disposed between the active matrix substrate 20 having thereon the TFT 94 and the pixel electrode 95 and the counter substrate 40 provided with the common electrode 42 to provide a liquid crystal capacitance (C_{1c}) 31.

Regarding the active matrix substrate 20, FIG. 3 shows an example using an a(amorphous)-Si TFT 94. More specifically, a TFT 94 is formed on a substrate 21 of glass, etc., by successively forming a gate electrode 22 connected to the gate lines G1, G1, . . . shown in FIG. 2, an insulating film (gate insulating film) 23 and an a-Si layer 24. On the a-Si layer 24, a source electrode 27 and a drain electrode 28 are disposed in separation from each other and via n⁺a-Si layers 25 and 26, respectively. The source electrode 27 is connected to one of the source lines S1, S2, . . . shown in FIG. 2, and the drain electrode 28 is connected to a pixel electrode 95 comprising a transparent conductor film, such as an ITO film. The a-Si layer 24 of the TFT 94 is further coated with a channel protection film 29. The TFT is turned on when a gate pulse is applied to the gate electrode 22 at the time of scanning selection of the corresponding gate line.

In the active matrix substrate 20, a holding capacitance (Cs) 32 can be formed by a structure sandwiching a portion of the insulating film 23 (also covering the gate electrode) with the pixel electrode 95 and a holding capacitor electrode 20 disposed on the substrate 31 in parallel with the liquid crystal capacitance (C_{1c}) given by the liquid crystal layer 49 as shown in FIG. 3. In case where a large area of the holding capacitor electrode 30 is required, the holding capacitor electrode 30 can be formed of a transparent conductor film, such as an ITO film, so as not to lower the aperture ratio.

Over the TFT 94 and the pixel electrode 95 of the active matrix substrate 20, a uniaxially aligned alignment control layer 43a for controlling the alignment state of the liquid crystal 49 is formed by the above-mentioned oblique deposition method. On the other hand, the counter substrate 40 is formed by coating a transparent 41 entirely with a common electrode 42 and an alignment control layer 43b respectively in a uniform layer. The alignment control layers 53a and 53b correspond to the alignment control layers 84a and 84b described with reference to FIG. 1.

As explained with reference to FIG. 1, the liquid crystal device shown in FIG. 3 can be constituted in a transmission type by sandwiching the structure between a pair of polarizers or in a reflection type by disposing a polarizer only on the counter substrate 40 side.

The TFT 24 can also be formed by using a polycrystalline Si (p-Si) layer instead of the a-Si layer 24.

The panel pixel portion shown in FIG. 3 can be represented by an equivalent circuit shown in FIG. 4, wherein a spontaneous polarization Ps of the liquid crystal is represented by an element 50, and identical numerals as in FIG. 3 represent corresponding members in FIG. 3.

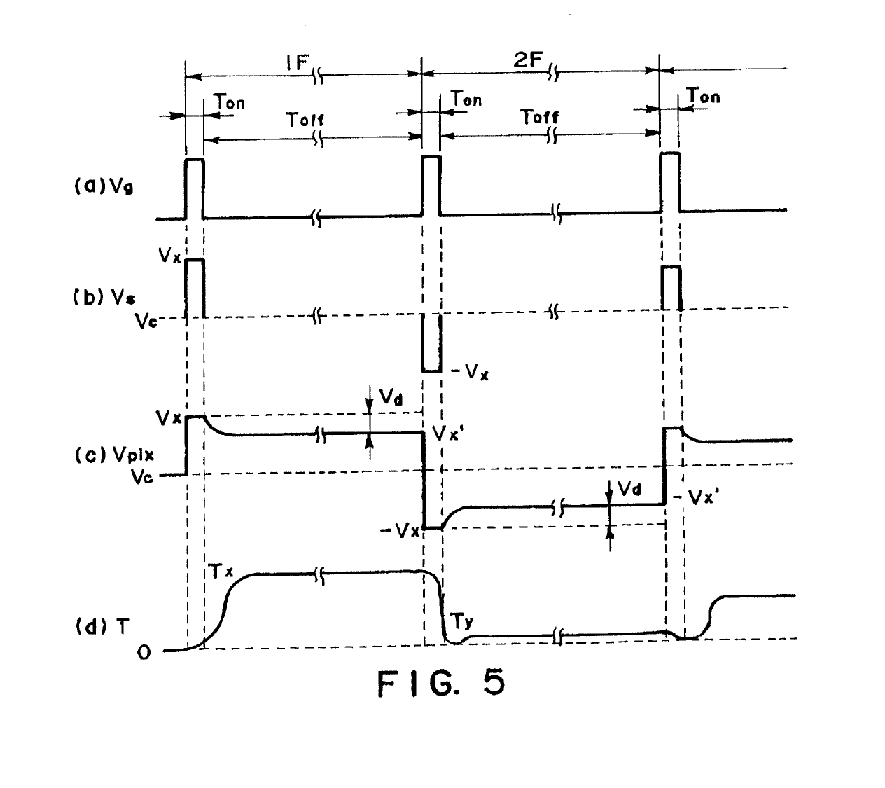

Referring to FIGS. 4 and 5, an active matrix drive of the liquid crystal device of the present invention will now be described. The liquid crystal device of the present invention may preferably be driven in such an active matrix drive mode that a period (one frame period) for displaying certain data at a pixel (and accordingly over a display panel) is divided into a plurality of unit periods (fields), e.g., two fields 1F and 2F shown in FIG. 5, and the polarity of voltage for data display at the pixel is inverted for each field to attain an emission light quantity on an average corresponding to prescribed data to be displayed at the pixel in the fields.

Hereinbelow, an active matrix driving method using a frame period divided into two fields and a liquid crystal material 49 having an alignment characteristic such that liquid crystal molecules are aligned or oriented to provide a sufficient transmitted light quantities under application of one-polarity voltage and smaller transmitted light quantities under application of the other-polarity voltage will be described.

Noting a certain one pixel, at FIG. 5(a) is shown a voltage applied to a gate line (scanning signal line) connected to the pixel. In the liquid crystal device described with reference to FIGS. 2 to 4, the gate lines G1, G2, . . . are selected, e.g., line-sequentially in each field, and one gate line is supplied with a prescribed gate voltage Vg at a selection period Ton which is applied to the gate electrode 22 to turn on the TFT 94 for the noted pixel. On the other hand, during a non-selection period Toff when the other gate lines are selected, the turn-on voltage Vg is not applied to the gate electrode 22 of the TFT 94 for the noted pixel, so that the TFT 94 is placed in a high-resistance state (off-state). At each Ton period for a noted pixel in each field, the gate line for the noted pixel is selected to turn on the TFT 94 for the noted pixel. The other gate lines are also selected once in each field for operation of the pixels thereon.

FIG. 5 shows at (b) a voltage waveform applied to one source line (e.g., S1 shown in FIG. 2) (as a data signal line) connected to the pixel concerned.

When the gate electrode 22 is supplied with the gate voltage Vg in the selection period Ton of each field 1F or 2F as shown at (a) of FIG. 5, in synchronism with this voltage application, a prescribed source voltage (data signal voltage) Vs having a prescribed potential providing a writing data (pulse) to the pixel concerned is applied to a source electrode 27 through the source line connected with the pixel based on a potential Vc of a common electrode 42 as a reference potential.

More specifically, in a first field (1F) in one frame period, a positive polarity source voltage at a level Vx corresponding to data written at the noted pixel, e.g., an optical state (transmitted light quantity) to be attained at the pixel, determined based on a voltage-transmittance (V-T) characteristic of the liquid crystal used, is supplied through a source line connected to the source electrode 27 of the TFT 94 for the noted pixel. As the TFT 94 is in the on-state, the voltage Vx applied to the source electrode 27 is applied via the drain electrode 28 to the pixel electrode 95, thereby charging the liquid crystal capacitance (C_{1c}) 31 and the holding capacitance (Cs) 32 to raise the potential of the pixel electrode to Vx (data signal voltage). Then, during the non-selection period Toff for the gate line for the noted pixel, the TFT 94 is placed in a high-resistance (off) state, the charge stored at the selection period Ton is retained at the liquid crystal capacitance (C_{1c}) 31 and the holding capacitance (Cs) 32. As a result, the liquid crystal layer 49 at the noted pixel is supplied with the voltage Vx throughout the first field (1F) to provide an optical state (transmittance) at the noted pixel. In this instance, however, in the case where the response time of the liquid crystal is larger than the gate “ON” period, a switching of the liquid crystal is effected in the non-selection period Toff (the gate “OFF” period) after the completion of the charging at the liquid crystal capacitance (C_{1c}) 31 and the storage capacitance (Cs) 32. In this case, the electrical charges stored of the capacitance are reduced due to inversion of spontaneous polarization Ps (50) to provide (positive-polarity) voltage Vx′ smaller than the voltage Vx by a voltage Vd as a pixel voltage Vpix applied to the liquid crystal layer 49 as shown at (c) of FIG. 5.

Then, at a selection period Ton for the gate line associated with the noted pixel in a second field (2F), a source voltage (−Vx) of an identical absolute value but an opposite polarity compared with the source voltage (Vx) applied in the first field (1F) is applied to the same source electrode 27 of the TFT 94 for the noted pixel. As the TFT 94 is in the on-state at this time, the voltage (−Vx) is applied to the pixel electrode 95 and retained at the liquid crystal capacitance (C_{1c}) 31 and the holding capacitance (Cs) 32 to place the pixel electrode at a potential (−Vx). Then, during the non-selection period Toff, the TFT 94 associated with the noted pixel is placed in a high-resistance (off) state, so that the charge stored at the selection period Ton is retained at the liquid crystal capacitance (C_{1c}) 31 and the holding capacitance (Cs) 32, thus retaining the voltage (−Vx). As a result, the liquid crystal layer 49 at the noted pixel is supplied with the voltage (−Vx) throughout the second field (2F) to provide an optical state (transmittance) corresponding to the voltage (−Vx) at the noted pixel.

In this instance, however, in the case where the response time of the liquid crystal is larger than the gate “ON” period, a switching of the liquid crystal is effected in the non-selection period Toff (the gate “OFF” period) after the completion of the charging at the liquid crystal capacitance (C_{1c}) 32 and the storage capacitance (Cs) 32. In this case, similarly as in the first period 1F, the electrical charges stored in the capacitances are reduced due to inversion of spontaneous polarization Ps (50) to provide (negative-polarity) voltage −Vx′ smaller than the voltage −Vx by a voltage Vd as a pixel voltage Vpix applied to the liquid crystal layer 49 as shown at (c) of FIG. 5.

At FIG. 5(c) is shown a time-serial change of voltage Vpix retained at the liquid crystal capacitance 31 and the holding capacitance 32 and applied to the liquid crystal layer, respectively at the noted pixel, and at FIG. 5(d) is shown a time-serial change of optical response (transmitted light quantity) at the noted pixel. As shown at FIG. 5(c), the voltages applied in the two fields 1F and 2F are at an identical level (absolute value) of Vx′ (−Vx′) of opposite polarities. On the other hand, as shown at FIG. 5(d), the noted pixel shows a gradational display state (transmittance) Tx corresponding to Vx′ (−Vx′) in the first field (1F), and a gradational display state (transmittance) Ty corresponding to −Vx′ in the subsequent second field (2F). The transmittance Ty in the second field is however only slight, substantially lower than Tx and close to zero level.

According to the above-mentioned active matrix drive scheme, the liquid crystal device of the present invention can be driven at a high speed for gradational display. A certain level of gradation is displayed at a pixel in successive two fields including a first field for displaying a high transmittance and a second field for displaying a low transmittance, whereby the resultant time-integrated aperture ratio becomes 50% or below, thus providing a motion picture high-speed responsiveness sensible to human eyes. Further, in the second field, the transmittance is not completed reduced to zero due to some switching operation of the liquid crystal molecules, so that the luminance level sensible to human eyes is ensured over the entire frame period.

Further, in the first and second fields, voltages of an identical absolute value and opposite polarities are applied to the liquid crystal layer 49, so that the voltages actually applied to the liquid crystal layer 49 are alternated to prevent the degradation of the liquid crystal

In the above-described matrix, an average of Tx and Ty is attained as an effective transmittance over one frame including two fields. Accordingly, it is also preferred that the data signal voltage Vs is set to be a value which is larger than a voltage giving a desired gradation level corresponding to a prescribed picture data to be displayed over a frame, thus displaying a higher transmittance than the desired gradation level in the first field (1F).

The liquid crystal device of the present invention may be applicable to a fullcolor liquid crystal display apparatus using the liquid crystal device in combination with a plurality of color light sources of at least red (R), green (G) and blue (B) without using a color filter, as desired, thus effecting color mixing in a time-division multiplexing manner.

Hereinbelow, the present invention will be described more specifically based on Examples.

### EXAMPLE 1

A chiral smectic liquid crystal composition LC-1 was prepared by mixing the following compounds in the indicated proportions.

| Structural formula | wt. % |
|---|---|
| 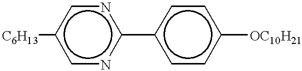 | 11.55 |
| 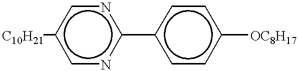 | 11.55 |
| 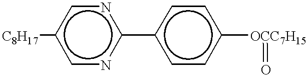 | 7.70 |
| 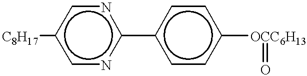 | 7.70 |
| 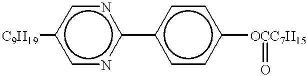 | 7.70 |
| 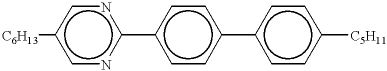 | 9.90 |
| 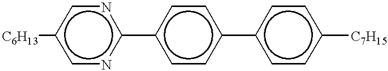 | 9.90 |
| 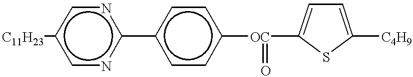 | 30.0 |
| 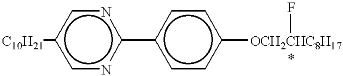 | 4.00 |

The thus-prepared liquid crystal composition LC-1 showed the following phase transition series and physical properties.

Phase Transition Temperature (C)

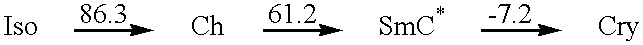

(Iso: isotropic phase, Ch: cholesteric phase, SmC*: chiral smectic C phase, Cry: crystal phase)

Spontaneous polarization (Ps): 2.9 nc/cm² (30° C.)

Tilt angle \mathring{H}: 23.3 degrees (30° C.), AC voltage=100 Hz and ±12.5 V, cell gap 1.4 μm)

Layer inclination angle δ: 21.6 degrees (30° C.)

Helical pitch (SmC*): at least 20 μm (30° C.)

The values of phase transition temperature (° C.) spontaneous polarization Ps, tilt angle \mathring{H}, and layer inclination angle δ in smectic layer referred to herein are based on values measured according to the following methods.

Measurement of Phase Transition Temperature (° C.)

The phase transition temperatures of the liquid crystal composition LC-1 were measured by using a DSC (differential scanning calorimeter) apparatus (“DSC Pyris 1”, mfd. by Perkin Elmer Co.). The measurement was performed on temperature decrease after the liquid crystal composition LC-1 kept at 100° C. for 1 minute was cooled to −30° C. at a rate of 5° C./min., kept at −30° C. for 5 min., and heated up to 100° C. at a rate of 5° C./min. As a result of measurement, the liquid crystal composition LC-1 did not assume smectic A phase (SmA).

Measurement of Spontaneous Polarization Ps

The spontaneous polarization Ps was measured according to “Direct Method with Triangular Waves for Measuring Spontaneous Polarization in Ferroelectric Liquid Crystal”, as described by K. Miyasato et al (Japanese J. Appl. Phys. 22, No. 10, pp. L661-(1983)).

Measurement of Tilt Angle \mathring{H}

A liquid crystal device was sandwiched between right angle-cross nicol polarizers and rotated horizontally relative to the polarizers under application of an AC voltage of ±12.5 V to ±50 V and 1 to 100 Hz between the upper and lower substrates of the device while measuring a transmittance through the device by a photomultiplier (available from Hamamatsu Photonics K.K.) to find a first extinct position (a position providing the lowest transmittance) and a second extinct position. A tilt angle \mathring{H} was measured as half of the angle between the first and second extinct positions.

Measurement of Liquid Crystal Layer Inclination Angle δ

The method used was basically similar to the method used by Clark and Largerwal (Japanese Display '86, Sep. 30-Oct. 2, 1986, p.p. 456-458) or the method of Ohuchi et al (J.J.A.P., 27 (5) (1988), p.p. 725-728). The measurement was performed by using a rotary cathode-type X-ray diffraction apparatus (available from MAC Science), and 80 μm-thick microsheets (available from Corning Glass Works) were used as the substrates so as to minimize the X-ray absorption with the glass substrates of the liquid crystal cells.

(Preparation of Liquid Crystal Cells A to E)

Five blank cells for liquid crystal cells A to E were each prepared in the following manner.

A pair of 1.1 mm-thick glass substrates each provided with a 70 nm-thick transparent electrode of ITO film was provided except that one of the pair of glass substrate was formed in an active matrix substrate provided with a plurality of a-Si TFTs and a silicone nitride (gate insulating) film and the other glass substrate (counter substrate) was provided with a color filter including color filter segments of red (R), green (G) and blue (B).

The thus prepared blank cell had a picture area size (diagonal length) of 3 inches including a multiplicity of pixels.

On each of the above-prepared active matrix substrate and the counter substrate, an alignment control film of SiO was formed in a thickness of 60 nm by using a vacuum deposition (evaporation) apparatus (“Model EBH 6”, mfd. by Nippon Shinku K.K.) under the following conditions:

Pressure (vacuum degree): 10⁻⁶ Torr

Deposition rate: 1 nm/sec

Deposition angle (θ_{DA}): 0 deg. (for cell A), 20 deg. (for cell B), 30 deg. (for cell C), 60 deg. (for cell D) and 80 deg. (for cell E)

Then, on one of the substrates, silica beads (average particle size 1.5 μm) were dispersed and, the thus-treated pair of substrates were applied to each other so that the deposition directions of the pair of substrates were in parallel with each other but oppositely directed (anti-parallel relationship) to prepare fine blank cells each with a uniform cell gap.

The liquid crystal composition LC-1 was injected into each of the above-prepared blank cells in its cholesteric phase state and gradually cooled to a temperature providing chiral smectic C phase to prepare a liquid crystal cells (panels) A, B, C, D and E different in deposition angle θ_{DA}. During the cooling step, at a temperature around the Ch-CmS* phase transition, the liquid crystal was supplied with a DC offset voltage of −2 volts.

(Preparation of Liquid Crystal Cell F)

A liquid crystal cell F was prepared in the same manner as in the liquid crystal cells A to E except that the SiO alignment control films (oblique-deposition films) were changed to polyimide alignment control films prepared in the following manner.

On each of a pair of substrates coated with ITO films, a polyimide precursor (“SE7992”, mid. by Nissan Kagaku K.K.) was spin-coated, followed by pre-drying at 80° C. for 5 min. and hot-baking at 200° C. for 1 hour to obtain a 50 nm polyimide film.

Each of the thus-obtained polyimide films was subjected to rubbing treatment (as a uniaxial aligning treatment) with a nylon cloth under the following conditions to provide a polyimide alignment control film.

Rubbing roller: a 10 cm-dia. roller about which a nylon cloth (“NF-77”, mfd. by Teijin K.K.) was wound.

Pressing depth: 0.3 mm

Substrate feed rate: 10 cm/sec

Rotation speed: 1000 rpm

Substrate feed: 4 times

The above-prepared liquid crystal cells A to E (having the SiO deposition films) and the liquid crystal cell F (having the rubbed polyimide films) were respectively evaluated with respect to a liquid crystal alignment state and a contrast.

The results are shown in Table 1.

TABLE 1

| LC | | | | |
|---|---|---|---|---|
| cell | θ_{DA} (deg.) | θ_{CA}* (deg.) | Alignment | Contrast |
| A | 0 | 90 | Random | Not |
| | | | | measurable |
| B | 20 | 80 | ″ | ″ |
| C | 30 | 70 | Uniaxial | 130 |
| D | 60 | 50 | ″ | 140 |
| E | 80 | 30 | ″ | 150 |
| F | — | — | ″ | 100 |

*) θ_{CA} (deg.) represent a column angle measured in the following manner.

A microphotograph of a cross section of a layer of deposited material (i.e., of the SiO deposition film) comprising a plurality of (obliquely) aligned columns was taken by using an electron microscope. An angle formed between a substrate surface (1) and a column extension (long-axis) direction (D_{CE}) was measured as a column angle θ_{CA} (deg.) as shown in FIG. 7C.

As apparent from Table 1, the liquid crystal cells C, D and E having a column angle θ_{CA} of at most 70 deg. exhibited higher contrasts than the liquid crystal cell F (using the rubbed polyimide film) while retaining uniform uniaxial alignment state (of liquid crystal molecules) without causing streaks as observed generally in the rubbed polyimide film and so-called zig-zag defect due to presence of C1 and C2 alignment states of chiral smectic liquid crystal.

As described hereinabove, according to the present invention, by using the chiral smectic liquid crystal having a phase transition series on temperature decrease of Iso-Ch-SmC* or Iso-SmC* in combination with an obliquely deposited alignment control film having a column angle of at most 70 degrees formed through oblique deposition, it is possible to readily prepare a chiral smectic liquid crystal device exhibiting a high contrast and a good liquid crystal alignment characteristic.

What is claimed is:

1. A chiral smectic liquid crystal device, comprising:
a chiral smectic liquid crystal,
a pair of substrates each provided with an electrode for applying a voltage to the liquid crystal and an alignment control layer formed by oblique vapor deposition, the pair of substrates being oppositely disposed to sandwich the liquid crystal so as to form a plurality of pixels each provided with an active element connected to an associated electrode on at least one of the substrates, and
a polarizer provided to at least one of the substrates; wherein
the liquid crystal has a phase transition series on temperature decrease of isotropic liquid phase (Iso), cholesteric phase (Ch) and chiral smectic C phase (SmC*) or of Iso and SmC*, and
the alignment control layer formed by oblique vapor deposition comprises a plurality of columns of deposited material forming an angle of at most 70 degrees with respect to an associated substrate so that liquid crystal molecules in the smectic phase are aligned substantially perpendicular to an extension direction of the columns of deposited material.

2. A device according to claim 1, wherein the liquid crystal has an alignment characteristic such that the liquid crystal is aligned to provide an average molecular axis to be placed in a monostable alignment state under no voltage application, is tilted from the monostable alignment state in one direction when supplied with a voltage of a first polarity at a tilting angle which varies depending on magnitude of the supplied voltage, and is tilted from the monostable alignment state in the other direction when supplied with a voltage of a second polarity opposite to the first polarity at a tilting angle, said tilting angles providing maximum tilting angles β1 and β2 formed under application of the voltages of the first and second polarities, respectively, satisfying β1>β2.

3. A device according to claim 2, wherein the maximum tilting angles β1 and β2 satisfy β1>5×β2.

4. A device according to claim 1, wherein the liquid crystal has an alignment characteristic such that the liquid crystal is aligned to provide an average molecular axis to be placed in a monostable alignment state under no voltage application, is tilted from the monostable alignment state in one direction when supplied with a voltage of a first polarity at a tilting angle which varies depending on magnitude of the supplied voltage, but is not substantially tilted from the monostable alignment state in the other direction when supplied with a voltage of a second polarity opposite to the first polarity.

5. A device according to claim 1, wherein the chiral smectic liquid crystal has a helical pitch in its bulk state larger than a value two times a cell thickness.
